(19) United States
(12) Patent Application Publication
(10) Pub. No.: US 2022/0405385 A1
(43) Pub. Date: Dec. 22, 2022

(54) SECURE CONTAINER CONSTRUCTION DEVICE AND METHOD EXECUTABLE BY ANDROID APPLICATION, AND COMPUTER-READABLE RECORDING MEDIUM ON WHICH PROGRAM THEREOF IS RECORDED

(71) Applicant: Foundation of Soongsil University-Industry Cooperation, SEOUL (KR)

(72) Inventors: Souhwan JUNG, Seoul (KR); Ngoc-Tu CHAU, Seoul (KR); Jungsoo PARK, Seoul (KR)

(21) Appl. No.: 17/784,483

(22) PCT Filed: Nov. 27, 2020
(86) PCT No.: PCT/KR2020/017016

§ 371 Date: Aug. 28, 2022

(30) Foreign Application Priority Data
Dec. 12, 2019 (KR) 10-2019-0165648
Mar. 4, 2020 (KR) 10-2020-0027118

(51) Int. Cl. G06F 21/53

(52) U.S. Cl. CPC G06F 21/53; G06F 2221/034

(57) ABSTRACT

Provided is a secure container construction device and method executable by an Android application, and a computer-readable recording medium on which a program thereof is recorded, the device and the method being capable of summoning a container at an application level without root privilege while showing performance that is faster than that of a conventional secure container technology, and thus can be implemented without invading an Android framework.

### TECHNICAL FIELD

The present invention relates to a secure container construction device and method executable by an Android application and a computer-readable recording medium on which a program thereof is recorded, the device and method being capable of invoking a container at an application level without root privilege while showing faster performance than a conventional secure container technology, and thus being able to be implemented without invading an Android framework.

### BACKGROUND ART

A container technology is similar to a virtual machine, but has a simplified isolation technology such that the container technology may share a kernel with a host operating system (OS). For this reason, the container technology is attracting attention as a technology that is faster and lighter than the conventional virtual machine.

Technologies such as Docker, which is a container implementation tool, Kubernetes, which is a container management tool, etc., are attracting attention in cloud environments, and are currently used by many companies.

Such a container shares the kernel with an OS. A container sharing the kernel with a host OS has the advantage of greatly reducing overhead, but there are also various vulnerabilities.

For example, when there is a vulnerability in the host kernel, privilege may be escalated using the vulnerability in the container. This may affect the host OS as well as container control.

Also, in the host OS, the container is run as one process. Accordingly, when a task requiring confidentiality is performed in the container, a method of restricting access by the host OS is separately required.

On the other hand, the virtual machine can implement a safer environment than the container technology. However, the virtual machine employs a method of virtualizing an entire system including a virtual central processing unit (CPU) or a virtual memory, and thus has drawbacks of a heavy weight and a heavy overhead.

Meanwhile, to solve the problems of the conventional container technology or virtual machine technology, the concept of a secure container employing a lightweight virtual machine was introduced.

A secure container may build an isolation environment using the lightweight virtual machine and inherit safety of the virtual machine. Also, overhead may be reduced by simplifying an OS in the virtual machine and by only executing a library and application to be used.

However, in an Android environment, an Android framework for directly calling and using a secure container at an Android application level is not yet provided to users.

This is because an Android framework does not allow an Android application to directly use a function provided by a Linux kernel module, and all Android applications are sandboxed.

Also, communication between processes should employ a binder that is a communication device provided by Android, and this is a reason that an Android application cannot directly execute a secure container.

### RELATED ART DOCUMENTS

### Patent Documents

(Patent Document 1) Korean Patent No. 10-1857009

(Patent Document 2) Korean Patent No. 10-1997061

### DISCLOSURE

### Technical Problem

The present invention is directed to providing a secure container construction device and method executable by an Android application and a computer-readable recording medium on which a program thereof is recorded, the device and method being capable of invoking a container at an application level without root authority while showing faster performance than a conventional secure container technology, and thus being able to be implemented without invading an Android framework.

### Technical Solution

One aspect of the present invention provides a secure container construction device executable by an Android application, the secure container construction device including a Linux kernel generation unit installed on an Android device and configured to generate a Linux kernel module supporting a virtualization environment in an Android kernel, a container service generation unit configured to generate an Android service module having access privilege to the Linux kernel module in an Android framework, and an application command processing unit configured to receive a command of an Android application and request secure container creation from the Android service module. A secure container is created by the Linux kernel module according to the secure container creation request.

The secure container may construct a communication function between the secure container and the Android service module, and the Android service module may construct a communication function between the Android application and the secure container.

The secure container construction device may further include a proxy configured to provide a console connected to the secure container to each application.

The Linux kernel module may be a kernel-based virtual machine (KVM) which is a Linux kernel module for implementing a lightweight virtual machine environment.

The KVM may perform virtualization for each virtual machine at a hardware level through a hypervisor mode provided in an advanced reduced-instruction-set-computer (RISC) machine (ARM) environment.

The KVM may use an lkvm binary, receive and cross-compile lkvm source code for an ARM architecture, and integrate and compile all dynamic libraries together into a static library.

The secure container may include a micro kernel as a kernel used in the secure container, and a BusyBox-based minimum root file system may be implemented as a root file system to be used for the secure container.

Another aspect of the present invention provides a secure container construction method executable by an Android application, the method including a virtual machine generation operation in which the Linux kernel generation unit generates a Linux kernel module, which is stored in a memory of an Android device to be executed by a processor and supports a virtualization environment, in an Android kernel, a system service generation operation in which a container service generation unit generates an Android service module having access privilege to the Linux kernel module in an Android framework, a container creation request operation in which an application command processing unit receives a command of an Android application and requests secure container creation from the Android service module, and a secure container creation operation in which the Linux kernel module receives the creation request through the Android service module and creates a secure container.

The secure container construction method may further include a first connection operation in which the secure container constructs a communication function between the secure container and the Android service module and a second connection operation in which the Android service module constructs a communication function between the Android application and the secure container.

The secure container construction method may further include a proxy operation in which the container service generation unit provides a console connected to the secure container to each application.

The virtual machine generation operation may be an operation of constructing a KVM which is a Linux kernel module for implementing a lightweight virtual machine environment.

In the virtual machine generation operation, virtualization for each virtual machine may be performed at a hardware level through a hypervisor mode provided in an ARM environment.

In the virtual machine generation operation, an lkvm binary may be used for using the KVM, lkvm source code may be received and cross-compiled for an ARM architecture, and all dynamic libraries may be integrated and compiled together into a static library.

In the secure container creation operation, a micro kernel may be built together as a kernel to be used in the secure container, and a BusyBox-based minimum root file system may be implemented as a root file system to be used for the secure container.

Another aspect of the present invention provides a computer-readable recording medium on which a computer program for performing the above secure container construction method executable by an Android application is recorded.

### Advantageous Effects

According to the above-described present invention, it is possible to directly invoke a container at an application level without root privilege while showing faster performance than the conventional secure container technology, and thus a secure container is implemented without invading an Android framework.

Therefore, the present invention provides an environment in which a secure container can be used at an application level and allows applications to run and terminate a secure container without rooting or administrator authority and execute a specific command in the secure container.

### DESCRIPTION OF DRAWINGS

FIG. 1 is a diagram showing an Android device to which a secure container construction device according to the present invention is applied.

FIG. 2 is a diagram showing a configuration of a secure container construction device executable by an Android application according to the present invention.

FIG. 3 is a diagram showing a secure container creation architecture implemented in an Android environment according to the present invention.

FIG. 4 is a diagram showing performance characteristics of created secure containers according to the present invention.

FIG. 5 is a flowchart illustrating a secure container construction method executable by an Android application according to the present invention.

### MODES OF THE INVENTION

Hereinafter, a secure container construction device and method executable by an Android application and a computer-readable recording medium on which a program thereof is recorded according to exemplary embodiments of the present invention will be described in detail with reference to the accompanying drawings.

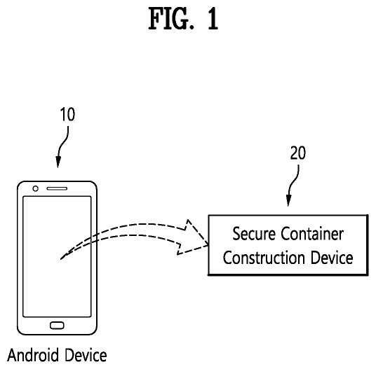

As shown in FIG. 1, a secure container construction device 20 executable by an Android application according to the present invention is installed and executed on an Android device 10. The Android device 10 includes a terminal device employing the Android operating system (OS).

The Android terminal device may include a mobile device. The mobile device is a device capable of wireless communication and has one of various forms such as a smartphone, a tablet computer, a laptop computer, a netbook, a personal digital assistant (PDA), a portable media player (PMP), a PlayStation Portable (PSP), a Moving Picture Experts Group (MPEG) layer 3 (MP3) player, an e-book reader, a navigation device, a smart camera, an e-dictionary, an electronic watch, a game device, etc.

Also, the mobile device may be referred to by another term, such as a device, an apparatus, a terminal, user-equipment (UE), a mobile station (MS), a wireless device, a handheld device, etc. having mobility, and executes various application programs on the basis of Android.

The application programs are programs developed to perform specific tasks using a mobile device. The application programs may include not only various applications, software tools, and process and service objects but also multimedia content, such as games, video, and photos, and all execution programs such as a viewer, a player, etc. for executing the multimedia content.

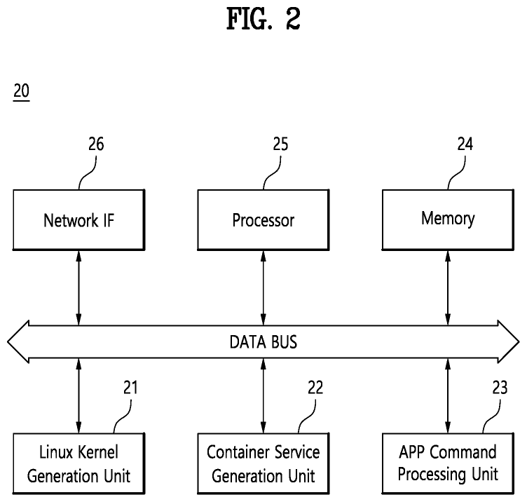

As shown in FIG. 2, the secure container construction device 20 executable by an Android application according to the present invention includes a Linux kernel generation unit 21, a container service generation unit 22, and an application command processing unit 23.

The Linux kernel generation unit 21 generates a Linux kernel module 11 in an Android kernel, and the container service generation unit 22 generates an Android service module 12 in an Android framework. The application command processing unit 23 makes a container creation request at a command of an Android application.

The above components may be implemented by a program processable by a processor 25. Accordingly, the secure container construction device 20 may be configured to further include a memory 24 and the processor 25 or may use process resources in connection with the memory 24 and the processor 25. A network interface 26 communicates with an external terminal and may be used for program downloading.

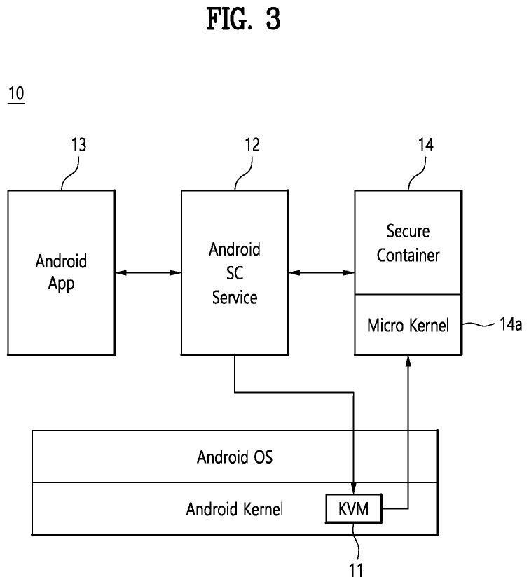

FIG. 3 shows a secure container creation architecture implemented in an Android environment according to the present invention.

As shown in the drawing, according to the present invention, a secure container environment executable at an application level is implemented in the Android device 10.

The Android secure container environment built in the Android device 10 includes the Linux kernel module 11, the Android service module 12, an Android application 13, and a secure container 14.

The Linux kernel module 11 generates the secure container 14 using a virtualization environment, and the Android service module 12 is generated to be included in the Android framework for running in an Android environment other than the Linux OS.

The Android application 13 requests container creation from the Linux kernel module 11 through the Android service module 12. After the secure container 14 is created, the Android application 13 directly communicates with the secure container 14 using a constructed communication function.

This present invention allows creation of the secure container 14 in an Android environment. Also, the secure container 14 can be invoked at the application level while showing fast performance, and thus the secure container 14 is implemented without invading the Android framework.

Therefore, it is possible to provide an environment in which the secure container 14 can be used at the application level, and applications can run and terminate the secure container 14 without rooting or administrator authority and execute a specific command in the secure container 14.

To this end, the above Linux kernel generation unit 21 generates the Linux kernel module 11 in the Android kernel which is present in a low level of the Android OS.

As a preferable example, the Linux kernel module 11 is a kernel-based virtual machine (KVM) which is the Linux kernel module 11 for implementing a lightweight virtual machine, and the KVM 11 is constructed in the Android kernel of the Android environment.

Since the Android kernel was derived and developed from the Linux kernel, it is possible to use functions provided by the Linux kernel. Accordingly, when the KVM 11 is applied to the Android kernel, it is possible to support a virtual central processing unit (VCPU), a virtual memory (VMEM), etc. for a virtualization environment.

Also, as an example, when a hypervisor (HYP) mode which is provided in an advanced reduced-instruction-set-computer (RISC) machine (ARM) mode is used, virtualization is possible for a virtual machine at a hardware level. For example, it is possible to provide system bus virtualization and CPU interrupt virtualization for a virtual machine.

For utilization of the KVM set in the Android kernel, an lkvm binary is preferably used. lkvm source code is received and cross-compiled for an ARM architecture, and all dynamic libraries are integrated and compiled into a static library.

Therefore, it is possible to build a kernel showing fast performance while providing a lightweight virtual machine environment to be optimized for the environment of a mobile device which shows lower performance than a cloud server.

The container service generation unit 22 generates the Android service module 12 to be included in the Android framework and have access privilege to the Linux kernel module 11. Accordingly, the Android application 13 is allowed to access the Linux kernel module 11 through the Android service module 12.

A general Android framework does not allow the Android application 13 to directly use a function provided by the Linux kernel module 11. Also, all applications of Android are sandboxed.

For this reason, the conventional communication between Android processes depends on a binder which is a communication device, and in order for the Android application 13 to run a container through the binder, it is necessary to register a corresponding service in the binder.

On the other hand, according to the present invention, the container service generation unit 22 generates the Android service module 12 in the Android framework, thereby allowing access to the Linux kernel module 11 and creation of the secure container 14 at the application level.

The generated Android service module 12 is added in the form of a system service that may be included in the Android framework in consideration of an Android environment which differs from the conventional Linux OS.

The Android service module 12 may have access privilege to an ARM-based lightweight virtual machine environment construction tool to create the secure container 14 and create or remove the secure container 14 according to a request of the Android application 13.

Preferably, the present invention further includes a proxy that provides a console connected to the secure container 14 to each application. As an example, the Android service module 12 may also serve as the proxy.

The application command processing unit 23 receives and executes a command of the Android application 13. For example, the application command processing unit 23 called by executing the Android application 13 processes the command.

The Android application 13 includes several applications that are implemented and executed at the application level. In particular, the Android application 13 of the present invention requests the Android service module 12 to create the secure container 14.

To this end, the application command processing unit 23 accesses the Android service module 12 according to the container creation request from the Android application 13 and transfers the container creation command.

Therefore, the Android application 13 can invoke the secure container 14 at the application level even without root privilege, and the secure container 14 can be implemented without invading the Android framework.

The secure container 14 is a new virtual environment construction technology that may have both the security of a virtual machine and the performance of a container technology. When creation is requested by the Android application 13, the secure container 14 is created by the Linux kernel module 11.

As an exemplary embodiment, the secure container 14 includes a micro kernel as a kernel used therein. As an example of the micro kernel of the secure container 14, a Zircon kernel is used.

The Zircon kernel is a kernel developed for the Google Fuchsia OS which is applied to embedded devices and has the advantage of providing basic scheduling and system calls. Also, the Zircon kernel can operate in several applications of various devices from a watch to a desktop.

In the present invention, a BusyBox-based minimum root file system is preferably implemented as a root file system used for the above secure container 14.

The root file system provides a BusyBox that only provides basic commands without a Daemon or additional services used in the Linux OS. Subsequently, like a Docker container image, applications and libraries to be executed in the secure container 14 are integrated on the basis of the base root file system such that the container is run.

Meanwhile, after the secure container 14 is created as described above, data communication is connected between the secure container 14 in the terminal device and an Android service and/or between the secure container 14 and the Android application 13.

To this end, the secure container 14 constructs a communication function between the secure container 14 and the Android service module 12, and the Android service module 12 constructs a communication function between the Android application 13 and the secure container 14.

Accordingly, the Android application 13 can directly use the secure container 14, and thus it is possible to run and terminate the secure container 14 without rooting or administrator authority and execute a specific command in the secure container 14.

However, as necessary, the container service generation unit 22 may construct the above communication functions in place of the secure container 14 and/or the Android service module 12, and substantially the same function may be provided accordingly.

A secure container construction device executable by an Android application according to the present invention has been described above.

As described above, the Android framework in which the secure container 14 can be used provides an environment in which the secure container 14 is created at a level of the application 13 running on Android.

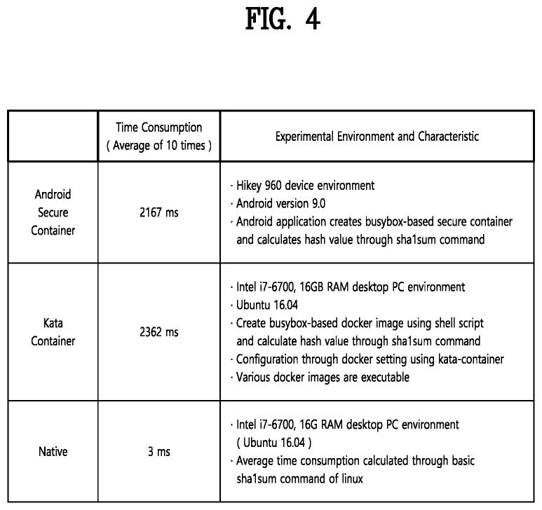

Further, as shown in FIG. 4, the present invention shows higher speed than a conventional secure container management tool.

The secure container 14 of the present invention was created in a Hikey960 device (4×Cortex A73+4×Cortex A53 big.LITTLE CPU architecture, 4 GB LPDDR4 DRAM, 32 GB UFS flash, Android 9.0) environment and then measured at an Android application level.

A Kata container corresponding to a conventional secure container technology was tested in an environment of Intel® Core™ i7-6700 CPU @ 3.40 GHz, 16 GB RAM, and Ubuntu 16.04. A BusyBox image was used in the test, and the time required for calculating a sha1sum value in each environment was calculated.

The required time was calculated by recording a pre-call timestamp and a post-call timestamp at the application level, and the average of required times calculated through 10 repetitions in each environment and characteristics are shown.

The case of Native shows the time required for performing the same task without a secure container in a Linux environment, and the overhead of each secure container was calculated using a very short task.

A secure container construction method executable by an Android application according to an exemplary embodiment of the present invention will be described below with reference to the accompanying drawings.

Since the following secure container construction method of the present invention is for the Android OS architecture described above with reference to FIG. 3, overlapping descriptions will be omitted if possible.

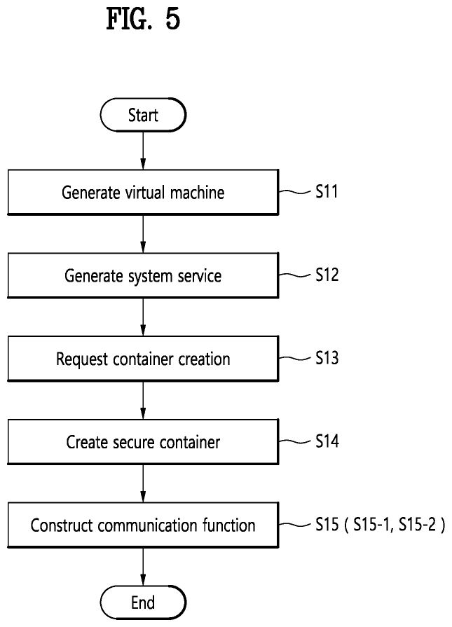

As shown in FIG. 5, the secure container construction method of the present invention includes a virtual machine generation operation S11, a system service generation operation S12, a container creation request operation S13, and a secure container creation operation S14. In addition, after creation of the secure container 14, the secure container construction method includes a connection operation S15 (S15-1 and S15-2) of constructing a communication function between modules.

This present invention may be performed in the Android device 10. The Android device 10 is typically a mobile terminal equipped with a computing function, such as a smartphone, which has already been described above.

In the virtual machine generation operation S11, the secure container 14 is created using a virtualization environment, and in the system service generation operation S12, a system service is constructed in an Android framework to be run in an Android environment.

In the container creation request operation S13, the Android application 13 requests container creation from the Linux kernel module 11 through the Android service module 12. Accordingly, in the secure container creation operation S14, the secure container 14 is created. After the secure container 14 is created, a communication function between modules is constructed.

This present invention creates the secure container 14 in the Android environment. Also, the present invention can invoke the secure container 14 at an application level while showing fast performance and thus creates the secure container 14 without invading the Android framework.

Therefore, it is possible to provide an environment in which the secure container 14 can be used at the application level, and applications can run and terminate the secure container 14 without rooting or administrator authority and execute a specific command in the secure container 14.

To this end, in the virtual machine generation operation S11, the Linux kernel module 11 which supports a virtualization environment is generated in the Android kernel which is present in a low level of the Android OS. This Linux kernel module 11 is generated by the Linux kernel generation unit 21.

As a preferable example, the Linux kernel module 11 constructs a KVM that is a Linux kernel module 11 for implementing a lightweight virtual machine. In other words, the KVM 11 is constructed in the Android kernel of the Android environment.

Since the Android kernel was derived and developed from the Linux kernel, it is possible to use functions provided by the Linux kernel. Accordingly, when the KVM is applied to the Android kernel, it is possible to support a VCPU, a VMEM, etc. which are a virtualization environment.

Also, as an example, when an HYP mode which is provided in an ARM mode is used, virtualization is possible for a virtual machine at a hardware level. For example, it is possible to provide system bus virtualization and CPU interrupt virtualization for a virtual machine.

For utilization of the KVM set in the Android kernel, an lkvm binary is preferably used. lkvm source code is received and cross-compiled for an ARM architecture, and all dynamic libraries are integrated and compiled into a static library.

Therefore, it is possible to build a kernel showing fast performance while providing a lightweight virtual machine environment to be optimized for the environment of a mobile device which shows lower performance than a cloud server.

Subsequently, in the system service generation operation S12, the Android service module 12, which is included in the Android framework and thus has access privilege to the Linux kernel module 11, is generated. The Android service module 12 is generated by the container service generation unit 22.

Since the Android service module 12 is constructed to be included in the Android framework, the Android service module 12 has access authority to the Linux kernel module 11. Accordingly, the Android application 13 can access the Linux kernel module 11 through the Android service module 12.

A general Android framework does not allow the Android application 13 to directly use a function provided by the Linux kernel module 11. Also, all applications of Android are sandboxed.

For this reason, the conventional communication between Android processes depends on a binder which is a communication device, and in order for the Android application 13 to run a container through the binder, it is necessary to register a corresponding service in the binder.

On the other hand, according to the present invention, the Android service module 12 is generated in the Android framework to ensure accessibility to the Linux kernel module 11 such that the Android application 13 can create or remove the secure container 14.

In this way, the Android service module 12 is additionally implemented in the form of a system service that may be included in the Android framework in consideration of an Android environment which differs from the conventional Linux OS.

Accordingly, the Android service module 12 may have access authority to an ARM-based lightweight virtual machine environment construction tool to create the secure container 14 and create or remove the secure container 14 at the application level.

However, the present invention further includes a proxy operation of providing a console connected to the secure container 14 to each application. The proxy operation can be performed after the secure container 14 is created, and may be performed by the container service generation unit 22 or the Android service module 12 generated by the container service generation unit 22.

Subsequently, in the container creation request operation S13, the Android application 13 requests container creation from the Android service module 12. Such a command of the Android application 13 is received and processed by the application command processing unit 23.

For example, the application command processing unit 23 which is called by executing the Android application 13 receives and transfers the container creation command to the Android service module 12.

The Android application 13 includes several applications that are implemented and executed at the application level. In particular, the Android application 13 requests the Android service module 12 to create the secure container 14.

Specifically, when the called application command processing unit 23 requests container creation from the Android service module 12, the Android service module 12 having an access authority to the Linux kernel module 11 requests container creation from the Linux kernel module 11.

Therefore, the Android application 13 can invoke the secure container 14 at the application level even without root privilege, and the secure container 14 can be implemented without invading the Android framework.

Subsequently, in the secure container creation operation S14, the Linux kernel module 11 receiving the creation request through the Android service module 12 creates the secure container 14.

The secure container 14 is a new virtual environment construction technology that may have both the security of a virtual machine and the performance of a container technology. The secure container 14 is created by the Linux kernel module 11 according to the creation request from the Android application 13.

As an exemplary embodiment, the secure container 14 is created together with a micro kernel used in the secure container 14. As an example of the micro kernel of the secure container 14, a Zircon kernel is used.

The Zircon kernel is a kernel developed for the Google Fuchsia OS which is applied to embedded devices and has the advantage of providing basic scheduling and system calls. Also, the Zircon kernel can operate in several applications of various devices from a watch to a desktop.

In the present invention, a BusyBox-based minimum root file system is preferably implemented as a root file system used for the above secure container 14.

The root file system provides a BusyBox that only provides basic commands without a Daemon or additional services used in the Linux OS. Subsequently, like a Docker container image, applications and libraries to be executed in the secure container 14 are integrated on the basis of the base root file system such that the container is run.

Subsequently, the connection operation S15 (S15-1 and S15-2) is an operation of constructing a communication function. After the secure container 14 is created, data communication is connected between the secure container 14 in the terminal device and an Android service and/or between the secure container 14 and the Android application 13.

To this end, the connection operation S15 includes the first connection operation S15-1 in which the secure container 14 constructs a communication function between the secure container 14 and the Android service module 12 and the second connection operation S15-2 in which the Android service module 12 constructs a communication function between the Android application 13 and the secure container 14.

Accordingly, the Android application 13 can directly use the secure container 14, and thus it is possible to run and terminate the secure container 14 without rooting or administrator authority and execute a specific command in the secure container 14.

However, as necessary, the above communication functions may be constructed by the container service generation unit 22 in place of the secure container 14 and/or the Android service module 12, and substantially the same function may be provided accordingly.

Meanwhile, a program for performing the secure container construction method executable by an Android application as described above is recorded on a computer-readable recording medium on which a computer program is recorded according to the present invention.

Therefore, methods according to embodiments of the present invention may be implemented as an application or in the form of program commands that can be executed through various computer components and may be recorded on the computer-readable recording medium.

The computer-readable recording medium may include program commands, data files, data structures, etc. solely or in combination. The program commands recorded thereon may be specially designed and configured for the present invention and may be known and available to those of ordinary skill in the field of computer software.

Examples of the computer-readable recording medium include hardware devices specially designed to store and execute program commands, such as a hard disk, optical recording media including a compact disc read-only memory (CD-ROM) and a digital versatile disc (DVD), magneto-optical media including a floptical disk, a ROM, a random access memory (RAM), a flash memory, etc.

Also, as a terminal device having a memory function, a mobile terminal having a computing function, such as a smartphone, is included. In particular, the mobile terminal is one of the various types of Android devices 10 described above. Further, a server may be included. The server is a download server or a cloud server that provides a download service for a corresponding program.

Specific embodiments of the present invention have been described above. However, those skilled in the technical field to which the present invention pertains should appreciate that the spirit and scope of the present invention are not limited to the specific embodiments and can be variously modified or altered without changing the gist of the present invention.

Therefore, the above-described embodiments are provided to fully inform those skilled in the technical field to which the present invention pertains of the scope of the present invention and thus should be understood as being illustrative rather than limitative. The present invention is only defined by the claims.

### DESCRIPTION OF SIGNS

10: Android device
11: Linux kernel module
12: Android service module
13: Android application
14: secure container
14a: micro kernel
20: secure container construction device
21: Linux kernel generation unit
22: container service generation unit
23: application command processing unit

1. A secure container construction device executable by an Android application, the secure container construction device comprising:
a Linux kernel generation unit installed on an Android device and configured to generate a Linux kernel module supporting a virtualization environment in an Android kernel;
a container service generation unit configured to generate an Android service module having access authority to the Linux kernel module in an Android framework; and
an application command processing unit configured to receive a command of the Android application and request the Android service module to create a secure container,
wherein the secure container is created by the Linux kernel module according to the request for creating the secure container 4.

2. The secure container construction device of claim 1, wherein the secure container constructs a communication function between the secure container and the Android service module, and
the Android service module constructs a communication function between the Android application and the secure container.

3. The secure container construction device of claim 1, further comprising a proxy configured to provide a console connected to the secure container to each of a plurality of applications.

4. The secure container construction device of claim 1, wherein the Linux kernel module is a kernel-based virtual machine which is a Linux kernel module for implementing a lightweight virtual machine environment.

5. The secure container construction device of claim 4, wherein the KVM performs virtualization for each of a plurality of virtual machines at a hardware level through a hypervisor (HYP) mode provided in an advanced reduced-instruction-set-computer (RISC) machine (ARM) environment.

6. The secure container construction device of claim 5, wherein the KVM uses an lkvm binary, receives and cross-compiles lkvm source code for an ARM architecture, and integrates and compiles all dynamic libraries together into a static library.

7. The secure container construction device of claim 1, wherein the secure container includes a micro kernel as a kernel used in the secure container, and
a BusyBox-based minimum root file system is implemented as a root file system to be used for the secure container.

8. A secure container construction method executable by an Android application, the secure container construction method comprising:
generating, by a Linux kernel generation unit, a Linux kernel module, which is stored in a memory of an Android device to be executed by a processor and supports a virtualization environment, in an Android kernel;
generating, by a container service generation unit generates an Android service module having access authority to the Linux kernel module in an Android framework;
receiving, by an application command processing unit, receives a command of the Android application and requesting the Android service module to create a secure container; and
receiving, by the Linux kernel module, the creation request through the Android service module and creating the secure container.

9. The secure container construction method of claim 8, further comprising:
constructing, by the secure container, a communication function between the secure container and the Android service module; and
constructing, by the Android service module, a communication function between the Android application and the secure container.

10. The secure container construction method of claim 8, further comprising providing, by a proxy, a console connected to the secure container to each of a plurality of applications.

11. The secure container construction method of claim 8, wherein generating, by the container service generation unit, the Linux kernel module in the Android kernel comprises constructing a kernel-based virtual machine (KVM) which is the Linux kernel module for implementing a lightweight virtual machine environment.

12. The secure container construction method of claim 11, wherein, in the generating, by the container service generation unit, the Linux kernel module in the Android kernel, virtualization for each of a plurality of virtual machines is performed by the KVM at a hardware level through a hypervisor mode provided in an advanced reduced-instruction-set-computer (RISC) machine (ARM) environment.

13. The secure container construction method of claim 12, wherein, in the generating the Linux kernel module in the Android kernel, an lkvm binary is used for using the KVM, lkvm source code is received and cross-compiled for an ARM architecture, and all dynamic libraries are integrated and compiled together into a static library.

14. The secure container construction method of claim 8, wherein, in the receiving, by the Linux kernel module, the creation request through the Android service module and creating the secure container, a micro kernel is built together as a kernel to be used in the secure container, and
a BusyBox-based minimum root file system is implemented as a root file system to be used for the secure container.

15. A non-transitory computer-readable recording medium on which a computer program for performing a secure container construction method executable by an Android application is recorded, wherein the secure container method comprises:
generating, by a Linux kernel generation unit, a Linux kernel module, which is stored in a memory of an Android device to be executed by a processor and supports a virtualization environment, in an Android kernel;
generating, by a container service generation unit, an Android service module having access authority to the Linux kernel module in an Android framework;
receiving, by an application command processing unit, a command of the Android application and requesting the Android service module to create a secure container; and
receiving, by the Linux kernel module, the creation request through the Android service module and creating the secure container.
